(19) United States
(12) Patent Application Publication
(10) Pub. No.: US 2016/0264185 A1
(43) Pub. Date: Sep. 15, 2016

(54) VEHICLE-HOOD LIFT SYSTEM

(71) Applicants: Andreas Heiko Keller, Dexter, MI (US); Brian F. VanderHaagen, Dexter, MI (US)

(72) Inventors: Andreas Heiko Keller, Dexter, MI (US); Brian F. VanderHaagen, Dexter, MI (US)

(21) Appl. No.: 14/644,276

(22) Filed: Mar. 11, 2015

(51) Int. Cl. B62D 25/12

(52) U.S. Cl. CPC B62D 25/12

(57) ABSTRACT

A vehicle-hood lift system that is designed to offset the force caused by the weight of a vehicle-hood. In one embodiment, two systems are used to raise or lower a vehicle-hood-one system secured to each side of the hood. The systems use a spring, typically a gas spring, that is secured to the vehicle-hood and vehicle fender.

### TECHNICAL FIELD

This disclosure relates to mechanical systems configured to offset a force. More particularly, it is in the field of spring powered systems for assisting in raising and lowering a vehicle-hood.

### BACKGROUND

This section contains general background material, which is not necessarily prior art.

Typically, vehicle-hoods can be difficult to lift and secure in place. In extreme cases, a person opening a vehicle-hood could lose their grip and the vehicle-hood could slam shut-endangering the person opening the vehicle-hood.

### BRIEF SUMMARY OF THE INVENTION

In one embodiment, a vehicle-hood lift system comprises: a hood bracket configured to attach to a vehicle-hood; a gas spring with a hood end and a fender end, wherein the gas spring is attached to the hood bracket at the hood end; a fender bracket comprising a male portion attached at the fender end of the gas spring, an intermediate section attached to the male portion, and a plate section attached to the intermediate section, wherein the plate section has a plate section opening; and a fastener configured to attach the system to a vehicle fender at the plate section opening.

The hood bracket can be an L-shaped bracket or the like. In a separate embodiment, the L-shaped bracket includes a ball stud that is configured to be mounted by rivets or screws to the vehicle-hood. In a separate embodiment, the L-shaped bracket includes a ball stud configured to mount to a vehicle-hood hinge bolt(s). In a separate embodiment, the hood bracket can be comprised of a threaded ball stud, washer, and insert that are configured to mount to a vehicle-hood opening.

The fender bracket male portion can be a ball stud. In one embodiment, fasteners such as rivets, screws, or the like are used to attach the plate section to a vehicle fender via the plate section opening.

In a separate embodiment, the fender bracket male portion is a ball stud configured to attach to a vehicle fender via a vehicle fender threaded hole, wherein the fender threaded hole is used to secure the fender bracket to the vehicle fender and the vehicle fender to the vehicle.

In a separate embodiment, the fender bracket male portion is a threaded ball stud configured to use a pre-existing vehicle fender threaded hole.

In a separate embodiment, the fender bracket comprises a bracket, a bolt, and an insert configured to utilize a pre-existing hole in a vehicle frame.

The gas spring has a capacity sufficient to mostly or fully offset the weight of the hood. In a separate embodiment, a mechanical spring is used instead of a gas spring.

In one embodiment, the male portion of the fender bracket can be a ball stud.

In one embodiment, the fastener apparatus comprises a bolt and retaining insert.

In one embodiment, a method to use a vehicle-hood-lift system comprises: attaching a hood bracket to a vehicle hood; attaching a fender bracket to a vehicle fender at a fender bracket plate section opening with a fastener, wherein the fender bracket comprises a male portion configured to attach to a gas spring, an intermediate section attached to the male portion, and a plate section attached to the intermediate section, wherein the plate section has the fender bracket plate section opening; and attaching a gas spring to the hood bracket and the fender bracket.

The scope of the invention is defined by the claims. A more complete understanding of embodiments on the present disclosure will be afforded to those skilled in the art, as well as the realization of additional advantages thereof, by consideration of the following detailed description of one or more embodiments. Reference will be made to the appended sheets of drawings that will first be described briefly.

### BRIEF DESCRIPTION OF THE DRAWINGS

This section briefly describes the accompanying drawings for this disclosure. All drawings are for illustrative and explanatory purposes only and not intended to limit the present invention to any example embodiments depicted herein.

FIG. 1 shows an exploded view of the fender bracket portion of the vehicle-hood lift system.

FIG. 2 shows a perspective view of the fender bracket portion of the vehicle-hood lift system.

FIG. 3 shows a perspective view of vehicle-hood lift system attached to a vehicle hood bracket.

FIG. 4 shows a perspective view of vehicle-hood lift system attached to a vehicle hood hinge assembly.

FIG. 5 shows an exploded view of a hood bracket embodiment.

FIG. 6 shows a perspective view of a hood bracket embodiment.

FIG. 7 shows an exploded view of a fender bracket embodiment.

FIG. 8 shows a perspective view of a fender bracket embodiment.

### DETAILED DESCRIPTION

This section contains descriptive content for this disclosure. It is also to be understood that the terminology and phraseology used herein is for explanatory and exemplary purposes and not intended to be limiting, as the scope of the present invention is defined ultimately by the claims herein (as amended).

The purpose of a vehicle-hood lift system is to offset the force caused by the weight of a vehicle-hood.

In one embodiment, two vehicle-hood lift systems are used for a vehicle-hood. One vehicle-hood lift system is installed on each side of the vehicle-hood. The hood lift systems are balanced to provide a consistent offset to force caused by the weight of the hood.

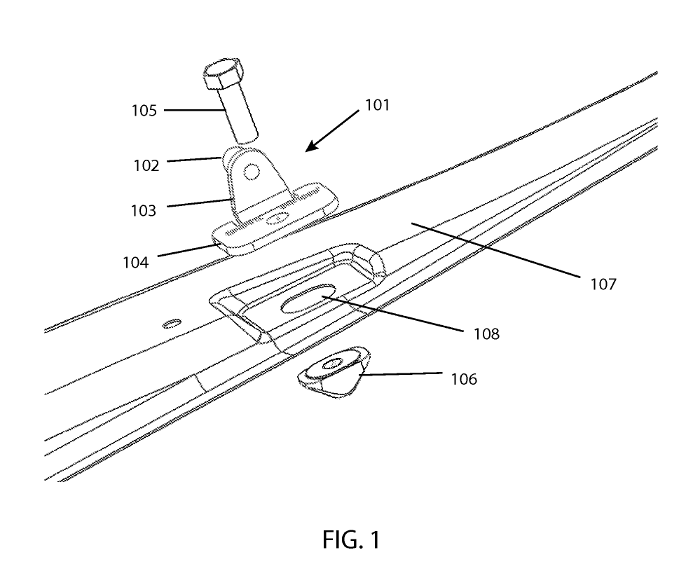

FIG. 1 shows an exploded view of the fender bracket portion of the vehicle-hood lift system. Shown are fender bracket 101, ball stud 102, intermediate section 103, plate section 104, bolt 105, retaining insert 106, vehicle sheet metal 107, vehicle sheet metal opening 108, and plate section opening 109. The ball stud 101 functions as a male portion and the retaining insert 106 functions as a fastener. The bolt 105 is inserted through the vehicle sheet metal opening 108 and plate section opening 109, then is secured with retaining insert 106. Retaining insert 106 has a larger cross-section area than vehicle sheet metal opening 108 and plate section opening 109.

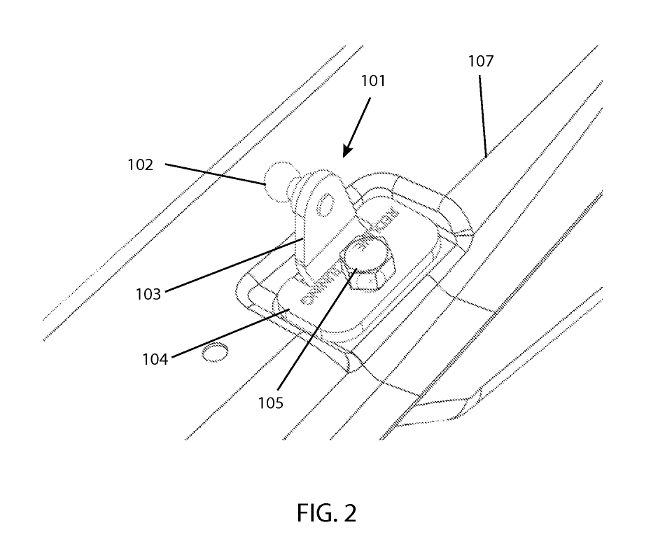

FIG. 2 shows a perspective view of the fender bracket portion of the vehicle-hood lift system. Shown are fender bracket 101, ball stud 102, intermediate section 103, plate section 104, bolt 105, and vehicle sheet metal 107.

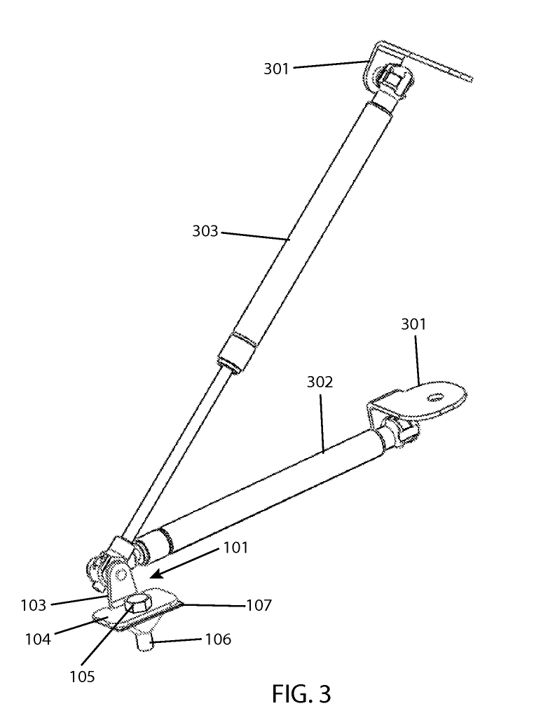

FIG. 3 shows a perspective view of vehicle-hood lift system attached to a vehicle hood bracket. Shown are hood bracket 301, gas spring in a compressed position 302, gas spring in an extended position 303, fender bracket 101, intermediate section 103, plate section 104, bolt 105, retaining insert 106, and vehicle sheet metal 107.

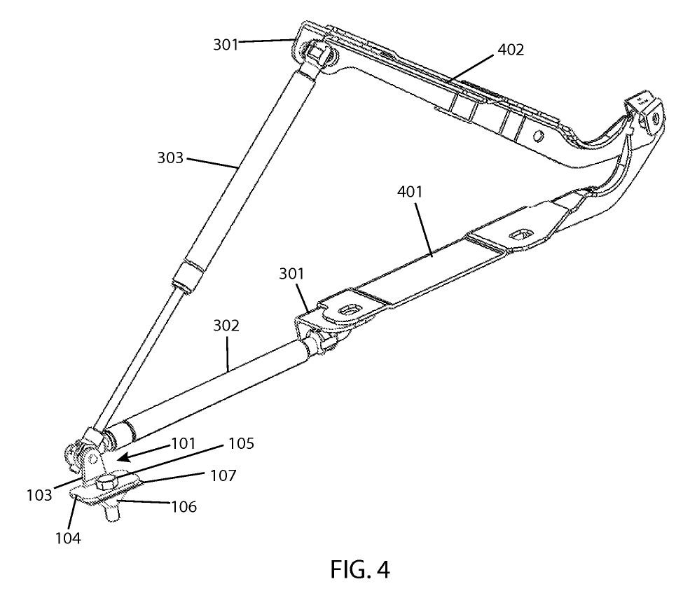

FIG. 4 shows a perspective view of vehicle-hood lift system attached to a vehicle hood hinge assembly. Shown are hood bracket 301, gas spring in a compressed position 302, gas spring in an extended position 303, fender bracket 101, intermediate section 103, plate section 104, bolt 105, retaining insert 106, vehicle sheet metal 107, hinge assembly in a closed position 401, and hinge assembly in an open position 402.

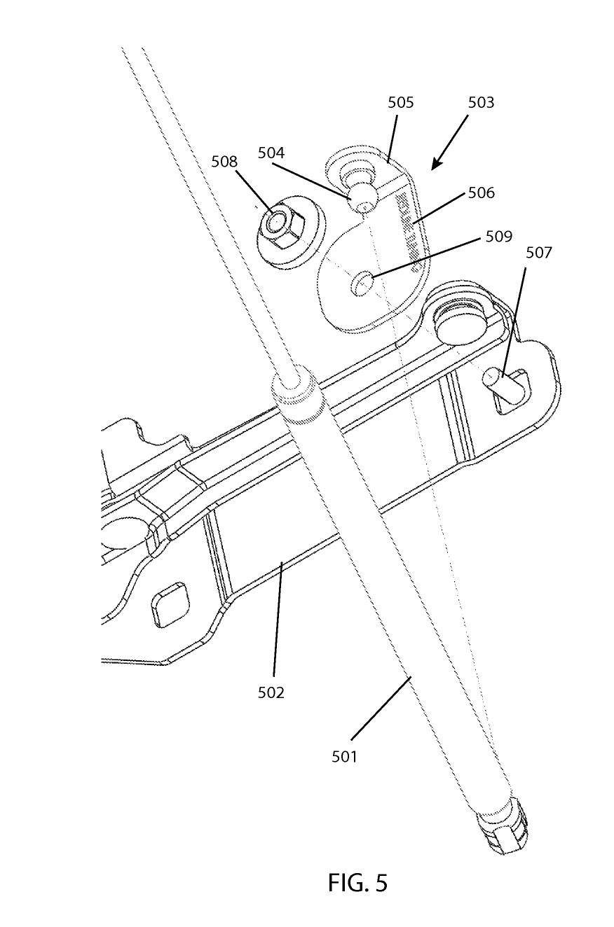

FIG. 5 shows an exploded view of a hood bracket embodiment. Shown are gas spring 501, vehicle-hood hinge assembly 502, hood bracket 503, hood bracket ball stud 504, hood bracket intermediate section 505, hood bracket plate section 506, vehicle-hood hinge assembly male section 507, vehicle-hood hinge retaining nut 508, and hood bracket plate section opening 509. The hood bracket ball stud 504 functions as a male portion and the vehicle-hood hinge retaining nut 508 functions as a fastener. The vehicle-hood hinge assembly male section 507 is inserted through the hood bracket plate section opening 509, then is secured with vehicle-hood hinge retaining nut 508. Vehicle-hood hinge retaining nut 508 has a larger cross-section area than hood bracket plate section opening 509.

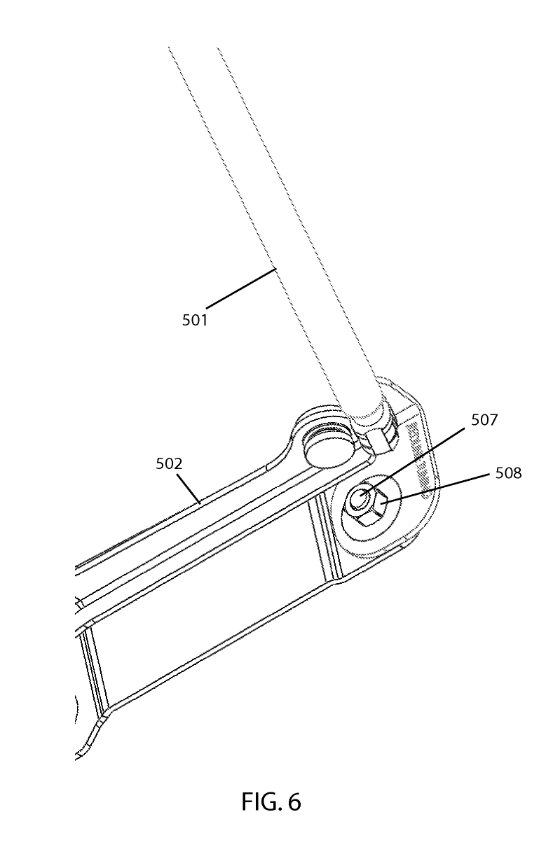

FIG. 6 shows a perspective view of a hood bracket embodiment. Shown are gas spring 501, vehicle-hood hinge assembly 502, vehicle-hood hinge assembly male section 507, and vehicle-hood hinge retaining nut 508.

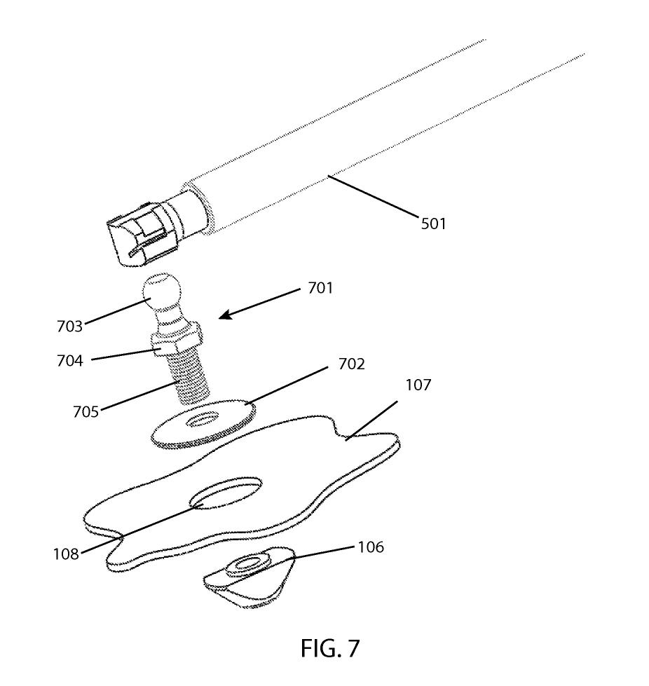

FIG. 7 shows an exploded view of a fender bracket embodiment. Shown are gas spring 501, fender connector 701, washer 702, fender connector ball stud section 703, fender connector intermediate section 704, fender connector threaded section 705, retaining insert 106, vehicle sheet metal 107, and vehicle sheet metal opening 108. The fender connector ball stud section 703 functions as a male portion and the retaining insert 106 functions as a fastener. The fender connector threaded section 705 is inserted through the washer 702 and vehicle sheet metal opening 108, and then is secured with retaining insert 106. Retaining insert 106 has a larger cross-section area vehicle sheet metal opening 108. Washer 702 has a larger diameter than vehicle sheet metal opening 108.

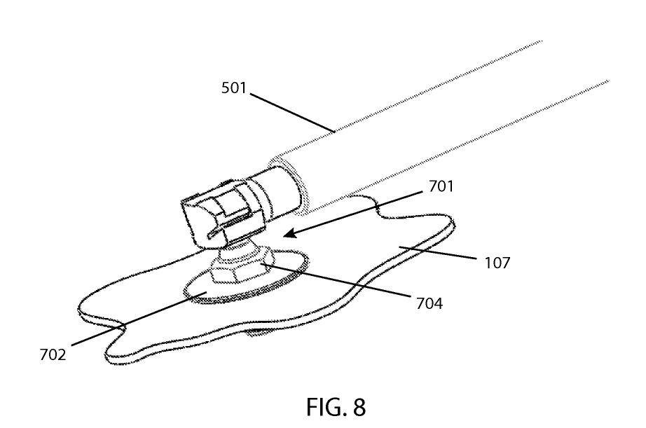

FIG. 8 shows a perspective view of a fender bracket embodiment. Shown are gas spring 501, fender connector 701, washer 702, fender connector intermediate section 704, and vehicle sheet metal 107.

This disclosure is enabling to those of ordinary skill in the art, while maintaining adequate flexibility for reasonable adaptation. Moreover, those skilled in the art will appreciate variations of the examples and principles described herein, which are also intended to be within the scope of the present invention. Any references herein to “the invention” or the like are thus intended in this spirit, as well as reflecting the respective subject matter of this particular filing.

We claim:

1. A vehicle-hood-lift system, the system comprising:
a hood bracket configured to attach to a vehicle-hood;
a gas spring with a hood end and a fender end, wherein the gas spring is attached to the hood bracket at the hood end and the fender bracket at the fender end;
a fender bracket comprising a male portion attached at the fender end of the gas spring, an intermediate section attached to the male portion, and a plate section attached to the intermediate section, wherein the plate section has a plate section opening; and
a fastener configured to attach the system to a vehicle fender at the plate section opening.

2. The system of claim 1, wherein the hood bracket is L-shaped.

3. The system of claim 1, wherein the male portion is a ball stud.

4. The system of claim 1, wherein the male portion is cylindrical.

5. The system of claim 1, wherein the fastener comprises a bolt and insert.

6. The system of claim 5, wherein the bolt is configured to pass through the plate section opening and a vehicle fender opening and be secured to the vehicle fender.

7. The system of claim 1, wherein the plate section has a rounded rectangular shape.

8. The system of claim 2, wherein the L-shaped bracket includes a ball stud that is configured to be mounted by rivets or screws to the vehicle-hood.

9. The system of claim 1, wherein the L-shaped bracket includes a ball stud configured to mount to a vehicle-hood hinge bolt(s).

10. The system of claim 1, wherein the hood bracket is comprised of a threaded ball stud, washer, and insert that are configured to mount to a vehicle-hood opening.

11. The system of claim 1, wherein fasteners is used to attach the plate section to a vehicle fender via the plate section opening.

12. The system of claim 1, wherein the fender bracket male portion is a ball stud configured to attach to a vehicle fender via a vehicle fender threaded hole, wherein the fender threaded hole is used to secure the fender bracket to the vehicle fender and the vehicle fender to the vehicle.

13. The system of claim 1, wherein the fender bracket male portion is a threaded ball stud configured to use a pre-existing vehicle fender threaded hole.

14. A vehicle-hood-lift system, the system comprising:
a hood bracket configured to attach to a vehicle-hood;
a gas spring with a hood end and a fender end, wherein the gas spring is attached to the hood bracket at the hood end;
a fender bracket comprising a bracket, a bolt, and an insert configured to utilize a pre-existing hole in a vehicle frame; and
a fastener configured to attach the system to a vehicle fender at the pre-existing hole in a vehicle frame.

15. A method to use a vehicle-hood-lift system, the method comprising:
attaching a hood bracket to a vehicle hood;
attaching a fender bracket to a vehicle fender at a fender bracket plate section opening with a fastener, wherein the fender bracket comprises a male portion configured to attach to a gas spring, an intermediate section attached to the male portion, and a plate section attached to the intermediate section, wherein the plate section has the fender bracket plate section opening; and
attaching a gas spring to the hood bracket and the fender bracket.

16. The method of claim 15, wherein the hood bracket is L-shaped.

17. The method of claim 15, wherein the male portion is a ball stud.

18. The method of claim 15, wherein the male portion is cylindrical.

19. The method of claim 15, wherein the fastener comprises a bolt and insert.

20. The method of claim 16, wherein the bolt is configured to pass through the plate section opening and a vehicle fender opening and be secured to the vehicle fender.
